(19) United States
(12) Patent Application Publication
(10) Pub. No.: US 2026/0247137 A1
(43) Pub. Date: Aug. 20, 2026

(54) METHOD AND DEVICE FOR ACCELERATION OF ARTIFICIAL INTELLIGENCE AND MACHINE LEARNING TRAINING IN WIRELESS COMMUNICATION SYSTEM

(71) Applicant: Samsung Electronics Co., Ltd., Suwon-si, Gyeonggi-do (KR)

(72) Inventors: Sunghwan KIM, Suwon-si (KR); Dongmyung KIM, Suwon-si (KR); Younggyoun MOON, Suwon-si (KR); Yoonseon HAN, Suwon-si (KR)

(21) Appl. No.: 19/159,877

(22) PCT Filed: Feb. 20, 2024
(86) PCT No.: PCT/KR2024/002157

§ 371 Date: Aug. 26, 2025

(30) Foreign Application Priority Data
Feb. 27, 2023 (KR) 10-2023-0025958

(51) Int. Cl. H04W 8/24; G06N 20/00

(52) U.S. Cl. CPC H04W 8/24; G06N 20/00

(57) ABSTRACT

The present disclosure relates to a 5G or 6G communication system for supporting a data transmission rate higher than that of a 4G communication system such as LTE. This operating method of an SMF for supporting federated learning in a wireless communication system comprises the steps of: acquiring information related to a plurality of terminals in a federated learning group; acquiring, from an NRF, first information related to a UPF, which supports gradient aggregation performance for federated learning; acquiring, from the NRF, second information related to an arrangement position of a programmable switch, which supports the gradient aggregation performance of the UPF; and selecting a UPF for the plurality of terminals in the federated learning group on the basis of the first information and/or the second information.

### TECHNICAL FIELD

The disclosure relates to a technology for supporting federated learning and, more specifically, to a method and a device for applying a method of accelerating artificial intelligence (AI)/machine learning (ML) training in a wireless communication system.

### BACKGROUND ART

A review of the development of wireless communication from generation to generation shows that the development has mostly been directed to technologies for services targeting humans, such as voice-based services, multimedia services, and data services. It is expected that connected devices which are exponentially increasing after commercialization of 5th generation (5G) communication systems will be connected to communication networks. Examples of things connected to networks may include vehicles, robots, drones, home appliances, displays, smart sensors installed in various infrastructures, construction machines, factory equipment, and the like. Mobile devices are expected to evolve into various formfactors, such as augmented reality glasses, virtual reality headsets, and hologram devices. In order to provide various services by connecting hundreds of billions of devices and things in the 6th generation (6G) era, there have been ongoing efforts to develop improved 6G communication systems. For these reasons, 6G communication systems are referred to as “beyond-5G” systems.

6G communication systems, which are expected to be implemented approximately by 2030, will have a maximum transmission rate of tera (i.e., 1,000 giga)-level bps and a radio latency of 100 μsec. That is, 6G communication systems will be 50 times as fast as 5G communication systems and have the 1/10 radio latency thereof.

In order to accomplish such a high data transmission rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, a technology capable of securing the signal transmission distance, that is, coverage, will become more crucial. It is necessary to develop, as major technologies for securing the coverage, multiantenna transmission technologies including radio frequency (RF) elements, antennas, novel waveforms having a better coverage than OFDM, beamforming and massive MIMO, full dimensional MIMO (FD-MIMO), array antennas, and large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the frequency efficiencies and system networks, the following technologies have been developed for 6G communication systems: a full-duplex technology for enabling an uplink (UE transmission) and a downlink (node B transmission) to simultaneously use the same frequency resource at the same time; a network technology for utilizing satellites, high-altitude platform stations (HAPS), and the like in an integrated manner; a network structure innovation technology for supporting mobile nodes B and the like and enabling network operation optimization and automation and the like; a dynamic spectrum sharing technology though collision avoidance based on spectrum use prediction, an artificial intelligence (AD)-based communication technology for implementing system optimization by using AI from the technology design step and internalizing end-to-end AI support functions; and a next-generation distributed computing technology for implementing a service having a complexity that exceeds the limit of UE computing ability by using super-high-performance communication and computing resources (mobile edge computing (MEC), clouds, and the like). In addition, attempts have been continuously made to further enhance connectivity between devices, further optimize networks, promote software implementation of network entities, and increase the openness of wireless communication through design of new protocols to be used in 6G communication systems, development of mechanisms for implementation of hardware-based security environments and secure use of data, and development of technologies for privacy maintenance methods.

It is expected that such research and development of 6G communication systems will enable the next hyper-connected experience in new dimensions through the hyper-connectivity of 6G communication systems that covers both connections between things and connections between humans and things. Specifically, it is expected that services such as truly immersive XR, high-fidelity mobile holograms, and digital replicas could be provided through 6G communication systems. In addition, with enhanced security and reliability, services such as remote surgery, industrial automation, and emergency response will be provided through 6G communication systems, and thus these services will be applied to various fields including industrial, medical, automobile, and home appliance fields.

Meanwhile, research on computing acceleration using programmable hardware (in-network computing (INC)) is very actively being conducted in data centers. By using programmable hardware, INC may reduce power consumption and cost for processing the same volume of traffic compared to existing technologies, and may achieve acceleration of AI training speed. However, existing technologies have considered only homogeneous and symmetric data center environments when applying gradient aggregation, and thus new designs are required for application to mobile (or wireless) communication systems. Accordingly, there is a growing demand for frameworks that support distributed AI/ML training, such as federated learning that requires privacy preservation, in mobile (or wireless) communication systems.

### DISCLOSURE OF INVENTION

### Technical Problem

A disclosed embodiment is to provide a device and a method for supporting acceleration of artificial intelligence (AI)/machine learning (ML).

### Solution to Problem

According to various embodiments disclosed herein, an operation method of a session management function (SMF) for supporting federated learning in a wireless communication system may include obtaining information on multiple terminals in a federated learning group, obtaining, from a network repository function (NRF), first information on a user plane function (UPF) supporting a gradient aggregation performance for federated learning, obtaining, from the NRF, second information on a placement position of a programmable switch supporting the gradient aggregation performance of the UPF, and selecting a UPF for the multiple terminals in the federated learning group, based on at least one of the first information and the second information, wherein in case that the gradient aggregation performance is supported, gradient aggregation is performed in the UPF, wherein in case that the gradient aggregation performance is not supported, the gradient aggregation is performed in a parameter server (PS), and wherein the gradient aggregation includes performing at least one of an arithmetic calculation or an exclusive OR (XOR) calculation for gradients of the multiple terminals.

According to various embodiments disclosed herein, an operation method of a user plane function (UPF) for supporting federated learning in a wireless communication system may include receiving a control message for multiple terminals in a federated learning group from a session management function (SMF), receiving gradients from the multiple terminals, based on the control message, performing aggregation for the gradients, based on whether aggregation is supported, and performing transmission to a parameter server (PS) or the multiple terminals, based on a post-processing capability of the multiple terminals, wherein gradient aggregation includes performing at least one of an arithmetic calculation or an exclusive OR (XOR) calculation for the gradients of the multiple terminals.

According to various embodiments disclosed herein, a session management function (SMF) for supporting federated learning in a wireless communication system may include at least one transceiver, and at least one processor operably coupled to the at least one transceiver, wherein the at least one processor is configured to obtain information on multiple terminals in a federated learning group, obtain, from a network repository function (NRF), first information on a user plane function (UPF) supporting a gradient aggregation performance for federated learning, obtain, from the NRF, second information on a placement position of a programmable switch supporting the gradient aggregation performance of the UPF, and select a UPF for the multiple terminals in the federated learning group, based on at least one of the first information and the second information, wherein in case that the gradient aggregation performance is supported, gradient aggregation is performed in the UPF, and wherein in case that the gradient aggregation performance is not supported, the gradient aggregation is performed in a parameter server (PS), and wherein the gradient aggregation includes performing at least one of an arithmetic calculation or an exclusive OR (XOR) calculation for gradients of the multiple terminals.

According to various embodiments disclosed herein, a user plane function (UPF) for supporting federated learning in a wireless communication system may include at least one transceiver, and at least one processor operably coupled to the at least one transceiver, wherein the at least one processor is configured to receive a control message for multiple terminals in a federated learning group from a session management function (SMF), receive gradients from the multiple terminals, based on the control message, perform aggregation for the gradients, based on whether aggregation is supported, and perform transmission to a parameter server (PS) or the multiple terminals, based on a post-processing capability of the multiple terminals, and wherein gradient aggregation includes performing at least one of an arithmetic calculation or an exclusive OR (XOR) calculation for the gradients of the multiple terminals.

### ADVANTAGEOUS EFFECTS OF INVENTION

A method and a device according to various embodiments of the disclosure can provide a change in a protocol to enable some of update calculations of a distributed artificial intelligence (AI) model to be processed in a switch rather than an application server, and provide a procedure allowing a gradient aggregation calculation to be performed in a switch, thereby improving the speed of distributed AI training, such as federated learning, compared to processing based on a server, such as an application server.

Advantageous effects obtainable from the disclosure may not be limited to the above-mentioned effects, and other effects which are not mentioned herein may be clearly understood from the following description by those skilled in the art to which the disclosure pertains.

### BRIEF DESCRIPTION OF DRAWINGS

FIG. 1 illustrates a communication network including core network entities (or core network functions) in a wireless communication system related to various embodiments of the disclosure.

FIG. 2 illustrates a wireless environment including a core network in a wireless communication system related to various embodiments of the disclosure.

FIG. 3 illustrates a structure of a core network entity in a wireless communication system according to various embodiments of the disclosure.

FIG. 4 illustrates a structure of a base station in a wireless communication system according to various embodiments of the disclosure.

FIG. 5 illustrates a structure of a UE in a wireless communication system according to various embodiments of the disclosure.

FIG. 6 illustrates a concept of a gradient aggregation method based on a parameter server (PS) related to various embodiments of the disclosure.

FIG. 7 illustrates a concept of a gradient aggregation method based on ring all reduce (RAR) related to various embodiments of the disclosure.

FIG. 8 illustrates a structure of a federated learning scenario of terminals related to various embodiments of the disclosure.

FIG. 9 illustrates a signal flow in a federated learning scenario of terminals related to various embodiments of the disclosure.

FIG. 10 illustrates a signal flow in a selection procedure for a terminal group related to various embodiments of the disclosure.

FIG. 11 illustrates a structure of a federated learning scenario of terminals according to various embodiments of the disclosure.

FIG. 12 illustrates a structure of a header including a weight value of each terminal according to various embodiments of the disclosure.

FIG. 13 illustrates an operation sequence of a session management function (SMF) according to various embodiments of the disclosure.

FIG. 14 illustrates a procedure for accelerating an update of artificial intelligence (AI)/machine learning (ML) according to various embodiments of the disclosure.

FIG. 15 illustrates a signal flow for supporting acceleration of an AI/ML update according to various embodiments of the disclosure.

FIG. 16 illustrates an operation sequence of a smart switch for supporting acceleration of an AI/ML update according to various embodiments of the disclosure.

FIG. 17 illustrates a signal flow for supporting acceleration of an AI/ML update according to various embodiments of the disclosure.

FIG. 18 illustrates an operation sequence of a smart switch for supporting acceleration of an AI/ML update according to various embodiments of the disclosure.

FIG. 19 illustrates a signal flow for supporting acceleration of an AI/ML update according to various embodiments of the disclosure.

FIG. 20 illustrates a signal flow for supporting acceleration of an AI/ML update according to various embodiments of the disclosure.

### MODE FOR THE INVENTION

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

In the following description, some of terms and names defined in the 3rd generation partnership project long term evolution (3GPP LTE)-based communication standards (e.g., standards for 5G, NR, LTE, or similar systems) may be used for the sake of descriptive convenience. However, the disclosure is not limited by these terms and names, and may be applied in the same way to systems that conform other standards.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used herein, and other terms referring to subjects having equivalent technical meanings may be used.

Meanwhile, as deep learning based on artificial neural networks (e.g., artificial intelligence (AI)/machine learning (ML)) are being utilized in various fields, the size of training data used in deep learning may gradually increase for more sophisticated training. Therefore, instead of processing data only on a single device, discussions are ongoing on parameter server-based data-parallel distributed deep learning, in which the gradients generated by dividing data across multiple devices and performing training are combined through a parameter server. However, a method (e.g., gradient aggregation) of transmitting gradients generated from multiple devices to a small number of parameter servers to combine (or merge) the gradients may concentrate traffic on the parameter servers and cause a bottleneck. Therefore, methods for solving the bottleneck problem of the gradient aggregation method are being discussed.

In addition, the following embodiments of the disclosure propose a change in a protocol to enable some of calculations for an update of a distributed AI model in a private network including personal information, to be processed in a switch rather than an application server (AS) (e.g., parameter server). The changed protocol may be called gradient aggregation offloading. A path control and a procedure enabling a gradient (e.g., weight or parameter) aggregation calculation to be processed in a switch, and a format of a general packet radio service (GPRS) tunneling protocol (GTP)-U extension header may be described.

That is, the following embodiments of the disclosure may describe methods for solving the bottleneck problem of the gradient aggregation method in a private network (e.g., mobile communication network) and accelerating training of an AI/ML model.

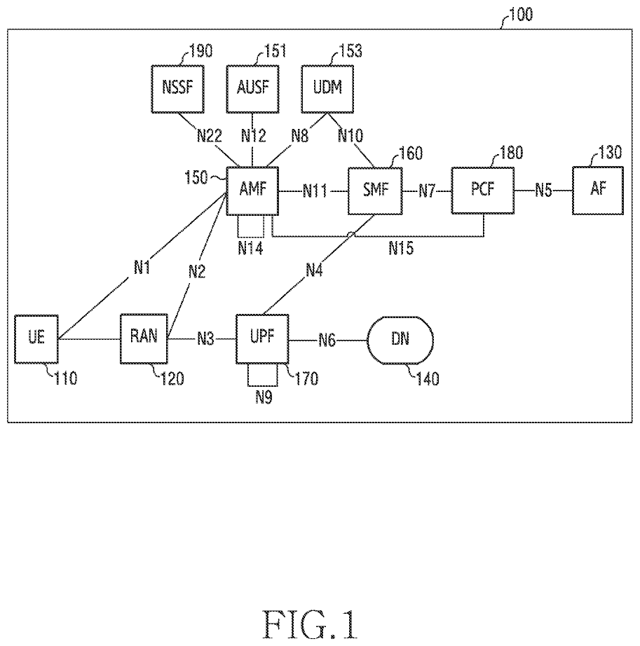

FIG. 1 illustrates a communication network 100 including core network entities (or core network functions) in a wireless communication system related to various embodiments of the disclosure. A 5G mobile communication network may include a 5G user equipment (UE) 110, a 5G radio access network (RAN) 120, and a 5G core network 200.

The 5G core network may include network functions including an access and mobility management function (AMF) 150 that provides a mobility management function for the UE, a session management function (SMF) 160 that provides a session management function, a user plane function (UPF) 170 that performs a data transfer role, a policy control function (PCF) 180 that provides a policy control function, a unified data management (UDM) 153 that provides a function of managing data, such as subscriber data and policy control data, or a unified data repository (UDR) that stores data of various network functions.

Referring to FIG. 1, the user equipment (UE) 110 may perform communication through a wireless channel, that is, an access network, which is established between the UE and a base station (e.g., eNB or gNB). In some embodiments, the UE 110 is a device that is used by a user, and may be a device configured to provide a user interface (UI). For example, the UE 110 may be a UE equipped in a vehicle for driving. In other embodiments, the UE 110 may be a device that performs machine type communication (MTC) operated without the user's involvement, or may be an autonomous vehicle. The UE may be called, as well as an electronic device, a “terminal,” a “vehicle terminal,” a “user equipment (UE),” a “mobile station,” a “subscriber station,” a “remote terminal,” a “wireless terminal,” “a user device,” or other terms having a technical meaning equivalent thereto.

Referring to FIG. 1, the AMF 150 may provide a function for access and mobility management in a unit of the UE 110, and one UE 110 may be basically connected to one AMF 150. Specifically, the AMF 150 may perform at least one function among signaling between core network nodes for mobility between 3GPP access networks, an interface (N2 interface) with the radio access network (e.g., 5G RAN) 120, NAS signaling with the UE 110, identification of the SMF 160, and provision of transfer of a session management (SM) message between the UE 110 and the SMF 160. Some or all functions of the AMF 150 may be supported in a single instance of one AMF 150.

Referring to FIG. 1, the SMF 160 may provide a session management function, and when the UE 110 has multiple sessions, the sessions may be managed by different SMFs 160. Specifically, the SMF 160 may perform at least one function among session management (e.g., session establishment, modification, and release with tunnel maintenance between the UPF 170 and an access network node), selection and control of a user plane (UP) function, configuration of traffic steering for routing traffic from the UPE 170 to a proper destination, an endpoint of an SM part of a NAS message, downlink data notification (DDN), and an initiator of AN-specific SM information (e.g., transfer to the access network through an N2 interface via the AMF 150). Some or all functions of the SMF 160 may be supported in a single instance of one SMF 160, A DN 140 may mean, for example, a network outside the 5G system, in which an operator service or an Internet access or 3rd party service exists. The DN may transmit a downlink protocol data unit (PDU) to the UPF, or receive a PDU transmitted from the UE via the UPF.

An AF 130 may interact with a 3GPP core network for service provision (e.g., support of a function, such as application influence on traffic routing, access to network capability exposure, and interaction with a policy framework for policy control).

Although not illustrated in FIG. 1, the 5G core network may include an NWDAF. The NWDAF may include at least one function of an analytics logical function (AnLF) and a model training logical function (MTLF), collect data in the 5G system, and provide an analytics service, based on the collected data. For example, the NWDAF may train a machine learning model, based on the data and provide analysis material required for network management and operation, based on the trained model.

In 3GPP systems, conceptual links connecting network functions (NFs) in the 5G system may be referred to as “reference points”. The reference points may also be referred to as “interfaces”. In the following, reference points included in the 5G system architecture described throughout FIG. 1 to FIG. 7 are exemplified below.
N1: a reference point between a UE 110 and an AMF 150
N2: a reference point between an (R)AN 120 and an AMF 150
N3: a reference point between an (R)AN 120 and a UPF 170
N4: a reference point between an SMF 160 and a UPF 170
N5: a reference point between a PCF 180 and an AF 130
N6: a reference point between a UPF 170 and a DN 140
N7: a reference point between an SMF 160 and a PCF 180
N8: a reference point between a UDM 153 and an AMF 150
N9: a reference point between two core UPFs 170
N10: a reference point between a UDM 153 and an SMF 160
N11: a reference point between an AMF 150 and an SMF 160
N12: a reference point between an AMF 150 and an authentication server function (AUSF) 151
N13: a reference point between a UDM 153 and an AUSF 151
N14: a reference point between two AMFs 150
N15: a reference point between a PCF 180 and an AMF 150 for a non-roaming scenario, and a reference point between a PCF 180 in a visited network and an AMF 150 for a roaming scenario

All or some of the NFs in the 3GPP 5G system described above may configure an enterprise private network to be described in the following embodiments of the disclosure. Specifically, all or some of the NFs in the 3GPP 5G system may interwork with a data network of an enterprise, and functions of the 5G system may be provided according to a requirement of the enterprise. However, only some functions of the NFs within the 5G system may be required, and it may be necessary to define a new network entity for providing the some functions. A new network entity for providing only some necessary functions according to the enterprise's requirement is specifically described in the embodiments of the disclosure below.

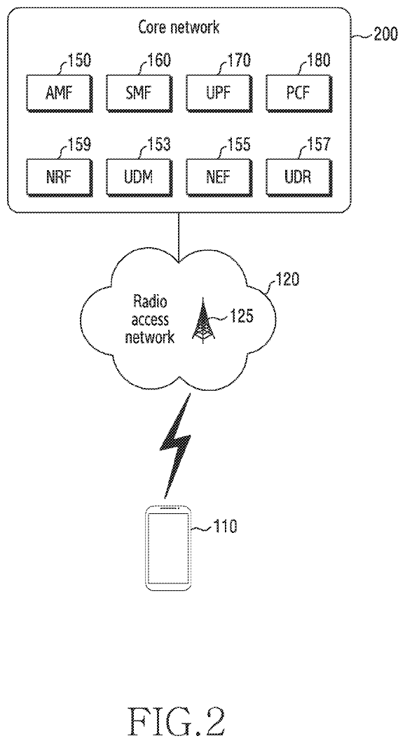

FIG. 2 illustrates a wireless environment including a core network in a wireless communication system related to various embodiments of the disclosure.

Referring to FIG. 2, a wireless communication system includes the radio access network (RAN) 120 and the core network (CN) 200.

The radio access network 120 is a network directly connected to a user device, for example, the UE 110, and is an infrastructure that provides wireless access to the UE 110. The radio access network 120 includes a set of multiple base stations including a base station 125, and the multiple base stations may perform communication through interfaces established between them. At least some of the interfaces between the multiple base stations may be wired or wireless. The base station 125 may have a structure in which a central unit (CU) and a distributed unit (DU) are separated from each other. In this case, one CU may control multiple DUs. The base station 125 may be called, other than a base station, an “access point (AP),” a “next generation node B (gNB),” a “5th generation node (5G node),” a “wireless point,” a “transmission/reception point (TRP),” or other terms having a technical meaning equivalent thereto. The UE 110 accesses the radio access network 120 and communicates with the base station 125 through a wireless channel. The UE 110 may be called, other than a terminal, a “user equipment (UE),” a “mobile station,” a “subscriber station,” a “remote terminal,” a “wireless terminal,” “a user device,” or other terms having a technical meaning equivalent thereto.

The core network 200 is a network that manages the entire system, and controls the radio access network 120 and processes data and control signals for the UE 110, which is transmitted or received via the radio access network 120. The core network 200 performs various functions including control of a user plane and a control plane, processing of mobility, management of subscriber information, charging, and linkage with a different type of system (e.g., long-term evolution (LTE) system). In order to perform the various functions, the core network 200 may include multiple entities that have different network functions (NFs) and are functionally separated from each other. For example, the core network 200 may include the AMF 150, the SMF 160, the UPF 170, the PCF 180, a network repository function (NRF) 159, the unified data management (UDM) 153, a network exposure function (NEF) 155, and a UDR 157.

The UE 110 is connected to the radio access network 120 to access the AMF 150 that performs a mobility management function for the core network 200. The AMF 150 may be a function or a device that serves both access to the radio access network 120 and mobility management for the UE 110. The SMF 160 is an NF that manages a session. The AMF 150 is connected to the SMF 160, and the AMF 150 routes a session-related message for the UE 110 to the SMF 160. The SMF 160 connects to the UPF 170 and allocates a user plane resource to be provided to the UE 110, and establishes a tunnel between the base station 125 and the UPF 170 for data transmission. The PCF 180 controls information related to charging and a policy for a session used by the UE 110. The NRF 159 performs a function of storing information on NFs installed in a mobile communication service provider network, and notifying of the stored information. The NRF 159 may be connected to all NFs. Each NF registers with the NRF 159 when starting operation in the service provider network, thereby notifying the NRF 159 that the NF is being operated in the network. The UDM 153 is an NF that performs a role similar to that of a home subscriber server (HSS) of a 4G network, and stores subscription information of the UE 110 or context used by the UE 110 in the network.

The NEF 155 performs a role of connecting a 3rd party server to an NF in a 5G mobile communication system. In addition, the NEF performs a role of providing or updating data to the UDR 157 or obtaining data therefrom. The UDR 157 performs a function of storing subscription information of the UE 120, storing policy information, storing data exposed to the outside, or storing information required for a 3rd party application. In addition, the UDR 157 performs a role of providing stored data to another NF.

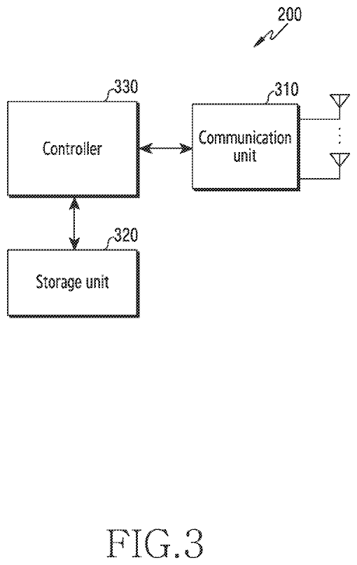

FIG. 3 illustrates a structure of a core network entity in a wireless communication system according to various embodiments of the disclosure. The structure 200 illustrated in FIG. 3 may be understood as a structure of a device having at least one of network functions 150, 153, 155, 157, 160, 170, 180, and 190 in FIG. 1. As used herein, such terms as “. . . unit” and “-er” refer to a unit configured to process at least one function or operation, and may be implemented as hardware, software, or a combination of hardware and software.

Referring to FIG. 3, the core network entity may include a communication unit 310, a storage unit 320, and a controller 330.

The communication unit 310 provides an interface for communicating with other devices in the network. That is, the communication unit 310 converts a bitstring, transmitted from the core network entity to any other device, into a physical signal, and converts a physical signal, received from any other device, into a bitstring. The communication unit 310 may transmit/receive signals. Accordingly, the communication unit 310 may be referred to as a modem, a transmitter, a receiver, or a transceiver. The communication unit 310 enables the core network entity to communicate with other devices or the system via a backhaul connection (e.g., wired backhaul or wireless backhaul) or via a network.

The storage unit 320 may store basic programs, application programs, and data, such as configuration information, for operation of the main base station. The storage unit 320 may include a volatile memory, a non-volatile memory, or a combination of a volatile memory and a non-volatile memory. In addition, the storage unit 320 provides the stored data at the request of the controller 330.

The controller 330 controls the overall operation of the core network entity. For example, the controller 330 transmits/receives signals through the communication unit 310. In addition, the controller330 records data in the storage unit 320 and reads the data from the storage unit 320. To this end, the controller 330 may include at least one processor. According to various embodiments, the controller 330 may control to perform synchronization by using a wireless communication network. For example, the controller 330 may control the core network entity to perform operations according to various embodiments as described below.

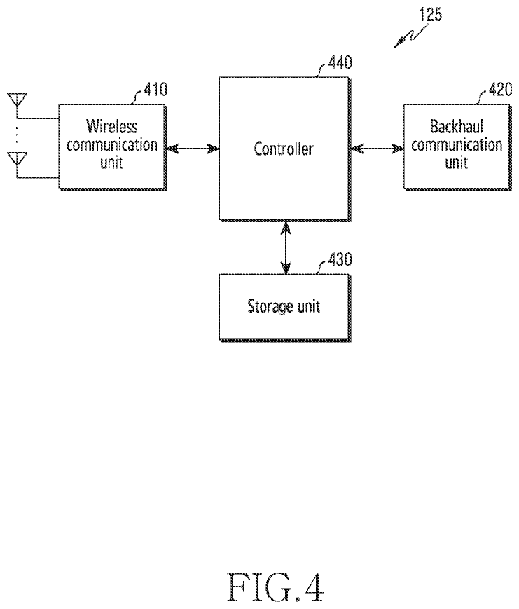

FIG. 4 illustrates a structure of a base station in a wireless communication system according to various embodiments of the disclosure. The structure illustrated in FIG. 4 may be understood as a structure of the base station 125. As used herein, such terms as “. . . unit” and “. . . er” refer to a unit configured to process at least one function or operation, and may be implemented as hardware, software, or a combination of hardware and software.

Referring to FIG. 4, the base station includes a wireless communication unit 410, a backhaul communication unit 420, a storage unit 430, and a controller 440.

The wireless communication unit 410 performs functions for transmitting/receiving signals through a radio channel. For example, the wireless communication unit 410 performs functions of conversion between baseband signals and bitstrings according to the physical layer specifications of the system. For example, during data transmission, the wireless communication unit 410 encodes and modulates a transmitted bitstring to generate complex symbols. In addition, during data reception, the wireless communication unit 410 demodulates and decodes a baseband signal to reconstruct a received bitstring.

Furthermore, the wireless communication unit 410 up-converts a baseband signal to an RF band signal, transmits the same through an antenna, and down-converts an RF band signal received through the antenna to a baseband signal. To this end, the wireless communication unit 410 may include a transmission filter, a reception filter, an amplifier, a mixer, an oscillator, a digital to analog converter (DAC), an analog to digital converter (ADC), and the like. In addition, the wireless communication unit 410 may include multiple transmission/reception paths. Furthermore, the wireless communication unit 410 may include at least one antenna array including multiple antenna elements.

In terms of hardware, the wireless communication unit 410 may include a digital unit and an analog unit, and the analog unit may include multiple sub-units according to operation power, frequencies, etc. The digital unit may be implemented by at least one digital signal processor (DSP).

The wireless communication unit 410 transmits and receives signals as described above. Accordingly, all or part of the wireless communication unit 410 may be referred to as a “transmitter”, a “receiver”, or a “transceiver”. In addition, as used in the following description, the meaning of “transmission and reception performed through a radio channel” includes the meaning that the above-described processing is performed by the wireless communication unit 410.

The backhaul communication unit 420 provides an interface for performing communication with other nodes in the network. That is, the backhaul communication unit 420 converts a bitstring, transmitted from the base station to any other node, for example, any other access node, any other base station, an upper node, or a core network, into a physical signal, and converts a physical signal, received from any other node, into a bitstring.

The storage unit 430 may store basic programs, application programs, and data, such as configuration information, for operation of the main base station. The storage unit 430 may include a volatile memory, a non-volatile memory, or a combination of a volatile memory and a non-volatile memory. In addition, the storage unit 430 provides the stored data at the request of the controller 440.

The controller 440 controls the overall operation of the base station. For example, the controller 440 transmits/receives signals through the wireless communication unit 410 or the backhaul communication unit 420. In addition, the controller 440 records data in the storage unit 430 and reads the data from the storage unit 430. Furthermore, the controller 440 may perform functions of protocol stacks required by communication specifications. According to another embodiment, the protocol stack may be included in the wireless communication unit 410. To this end, the controller 440 may include at least one processor. According to various embodiments, the controller 440 may control the base station to perform operations according to various embodiments as described below.

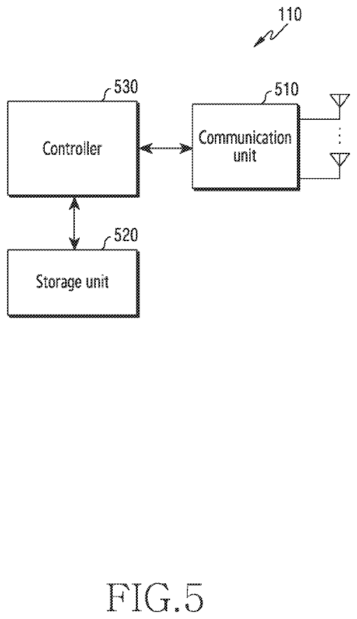

FIG. 5 illustrates a structure of a UE in a wireless communication system according to various embodiments of the disclosure. The structure illustrated in FIG. S may be understood as a structure of the UE 110. As used herein, such terms as “. . . unit” and “. . . er” refer to a unit configured to process at least one function or operation, and may be implemented as hardware, software, or a combination of hardware and software.

Referring to FIG. 5, the UE may include a communication unit 510, a storage unit 520, and a controller 530.

The communication unit 510 performs functions for transmitting/receiving signals through a radio channel. For example, the communication unit 510 performs functions of conversion between baseband signals and bitstrings according to the physical layer specifications of the system. For example, during data transmission, the communication unit 510 generates complex symbols by encoding and modulating a transmission bitstream. In addition, during data reception, the communication unit 510 demodulates and decodes a baseband signal to restore a received bitstring. In addition, the communication unit 510 up-converts a baseband signal to an RF band signal, transmits the same through an antenna, and down-converts an RF band signal received through the antenna to a baseband signal. For example, the communication unit 510 may include a transmission filter, a reception filter, an amplifier, a mixer, an oscillator, a DAC, and an ADC.

In addition, the communication unit 510 may include multiple transmission/reception paths. Moreover, the communication unit 510 may include at least one antenna array including multiple antenna elements. In terms of hardware, the communication unit 510 may include a digital circuit and an analog circuit (e.g., a radio frequency integrated circuit (RFIC)), The digital circuit and the analog circuit may be implemented as a single package. In addition, the communication unit 510 may include multiple RF chains. Furthermore, the communication unit 510 may perform beamforming.

The communication unit 510 transmits and receives signals as described above. Accordingly, all or part of the communication unit 510 may be referred to as a “transmitter”, a “receiver”, or a “transceiver”. In addition, as used in the following description, the meaning of “transmission and reception performed through a radio channel” includes the meaning that the above-described processing is performed by the communication unit 510.

The storage unit 520 may store basic programs, application programs, and data, such as configuration information, for operation of the main base station. The storage unit 520 may include a volatile memory, a non-volatile memory, or a combination of a volatile memory and a non-volatile memory. In addition, the storage unit 520 provides the stored data at the request of the controller 530.

The controller 530 controls the overall operation of the UE. For example, the controller 530 transmits/receives signals through the communication unit 510. In addition, the controller 530 records data in the storage unit 520 and reads the data from the storage unit 520. In addition, the controller 530 may perform functions of protocol stacks required by communication specifications. To this end, the controller 530 may include at least one processor or microprocessor, or may be a part of a processor. In addition, a part of the communication unit 510 and the controller 530 may be referred to as a communication processor (CP). According to various embodiments, the controller 530 may control the UE to perform operations according to various embodiments as described below.

Hereinafter, a method of accelerating an update of a local AI/machine learning (ML) model is described in embodiments of the disclosure. Hereinafter, a local (or global) model may indicate a local (or global) AI/ML model, and a global model may indicate an AI/ML model to be applied to all the local models. In addition, hereinafter, an update of an AI/ML model may be used as the same meaning as training of an AI/ML model.

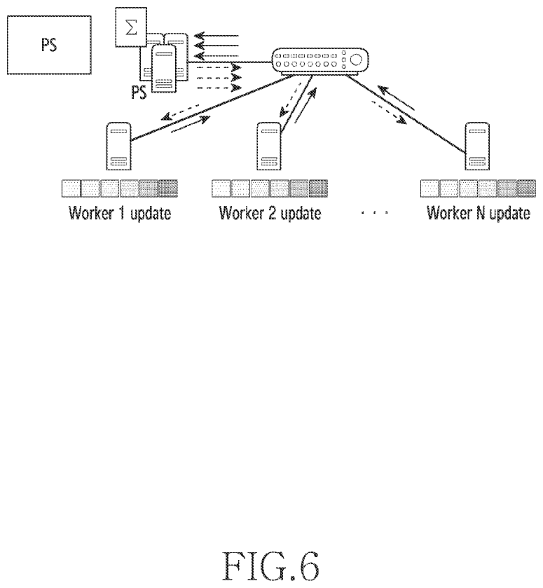

FIG. 6 illustrates a concept of a gradient aggregation method based on a parameter server (PS) related to various embodiments of the disclosure.

Referring to FIG. 6, an embodiment of a gradient aggregation method for distributed AI/ML training in a data center may be described. Each worker may indicate an entity which may collect and learn data. Each worker may train an AI/ML model, based on collected data, and transmit data of the updated AI/ML model to an application server (e.g., parameter server).

Specifically, each worker may calculate a gradient, based on collected data and update a local model (e.g., each local AI/ML model). The data collected by each worker may include weight values received from multiple end nodes (e.g., UEs), and the gradient may be a concept including the variation (or change degree) of the weight values of multiple end nodes (e.g., UEs). For example, the variation (or change degree) of local weight values transmitted by multiple end nodes (e.g., UEs) may be called a gradient. Therefore, each worker may transmit, to the parameter server, a gradient obtained based on the weight values received from multiple end nodes (e.g., UEs).

The parameter server may perform a gradient aggregation operation, based on gradients received from the workers. For example, the parameter server may perform a calculation, such as an arithmetic calculation, exclusive OR (XOR), an average calculation, a median calculation, or a mode calculation for the gradients received from the workers, and the calculation may be called gradient aggregation. A mode may refer to the most frequently observed value, that is, the value that appears most often among the given values. The parameter server may update (e.g., train) a global model (e.g., an integrated AI/ML model to be applied to all the local AI/ML models) through gradient aggregation. Thereafter, the parameter server may update all the local AI/ML models by transmitting data about the updated global model to each worker. That is, the above embodiment may correspond to a method in which gradient aggregation for an update of an AI/ML model is performed in a data center (e.g., application server).

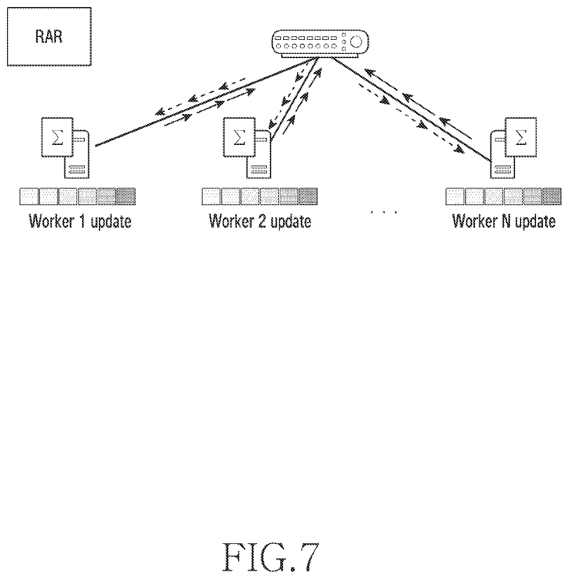

FIG. 7 illustrates a concept of a gradient aggregation method based on ring all reduce (RAR) related to various embodiments of the disclosure.

Referring to FIG. 7, an embodiment of a gradient aggregation method for distributed AI/ML training in a data center may be described. Each worker may perform an AI/ML update based on ring topology. An AI/ML update technique based on ring topology may be called a collective communications technique.

Specifically, each worker perform a gradient aggregation operation through weight values received from at least one end node (e.g., UE). The gradient aggregation operation may be the same operation as performed by a parameter server in FIG. 6 described above. Therefore, each worker may update a corresponding local AI/ML model and exchange data about the updated AI/ML model with each other. That is, an embodiment of FIG. 7 corresponds to a method in which gradient aggregation for an update of an AI/ML model is performed between the workers without a parameter server.

However, the gradient aggregation method for distributed AI/ML training in FIG. 6 or FIG. 7 described above may correspond to a method of transmitting local gradients to a parameter server or coordinator server and performing aggregation by using SwitchML. SwitchML may indicate a distributed ML system that accelerates data-parallel training by using a programming protocol-independent packet processor (P4) switch.

On the contrary, a method proposed in the following embodiments of the disclosure may be a method of selecting a particular aggregation point (e.g., logical UPF) to perform aggregation during transmission of local gradients. Therefore, a method of performing multiple calculations (e.g., including at least one of an arithmetic calculation or XOR) in a switch (e.g., a programmable switch) included in a logical UPF, thereby performing gradient aggregation may be described. Hereinafter, in embodiments of the disclosure, a programmable switch capable of performing gradient aggregation may be called a smart switch or a switch, and a UPF including a smart switch may be called a logical UPF or a UPF.

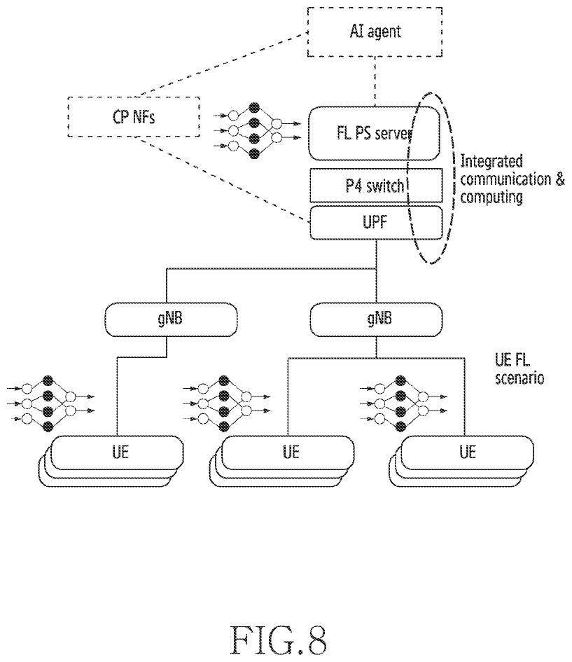

FIG. 8 illustrates a structure of a federated learning (FL) scenario of UEs related to various embodiments of the disclosure.

FIG. 8 may show an embodiment of a UE federated learning scenario in which the gradient aggregation method for distributed AI/ML training described above with reference with FIG. 6 or FIG. 7 is applied to a mobile communication system (or wireless communication system). The gradient aggregation method for distributed AI/ML training in FIG. 6 or FIG. 7 described above may correspond to a method of transmitting local gradients to a parameter server or coordinator server and performing aggregation by using SwitchML. SwitchML may indicate a distributed ML system that accelerates data-parallel training by using a programming protocol-independent packet processor (P4) switch.

Specifically, multiple UEs which are to participate in federated learning may transmit pieces of training data for updating an AI/ML model to corresponding base stations (e.g., gNBs) providing a service. Each base station may transmit collected pieces of training data to a network entity (e.g., UPF) of a 5G system. For example, the UPF, NFs of another control plane (CP), and an AI agent may perform integrated communication and computing with an FL PS through a P4 switch of the UPF, and the UPF may operate in an integrated communication and computing operation in conjunction with the NFs of the other control plane (CP) and the AI agent.

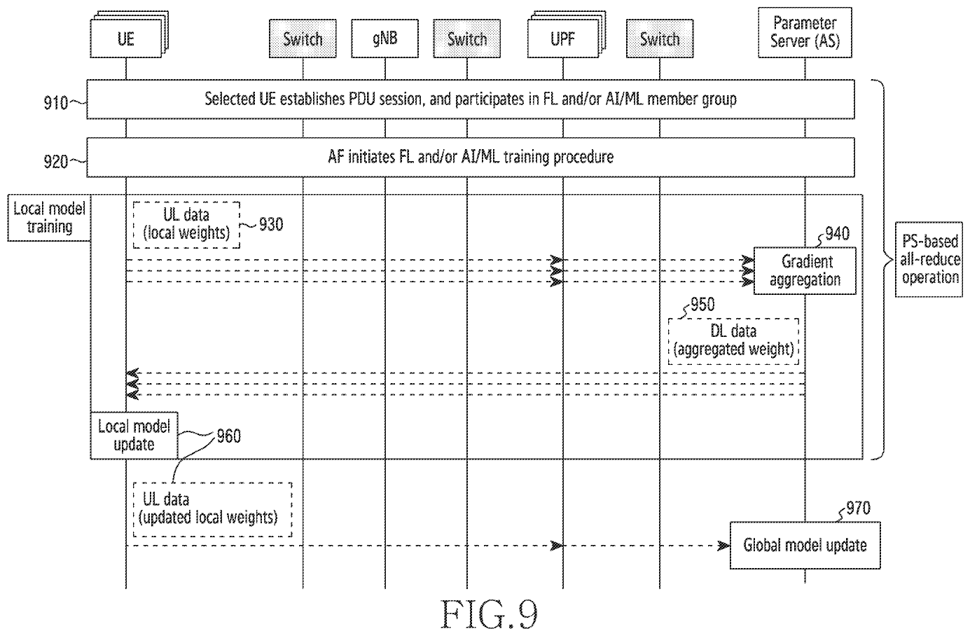

FIG. 9 illustrates a signal flow in a federated learning scenario of UEs related to various embodiments of the disclosure.

Referring to FIG. 9, signaling between nodes (or network entities) according to the UE federated learning scenario of FIG. 8 described above may be described.

In operation 910, UEs which are to participate in federated learning may be selected by a parameter server, and the selected UEs may establish protocol data unit (PDU) sessions through an SMF. In addition, the selected UEs may participate in a federated learning and/or distributed AI/ML member group.

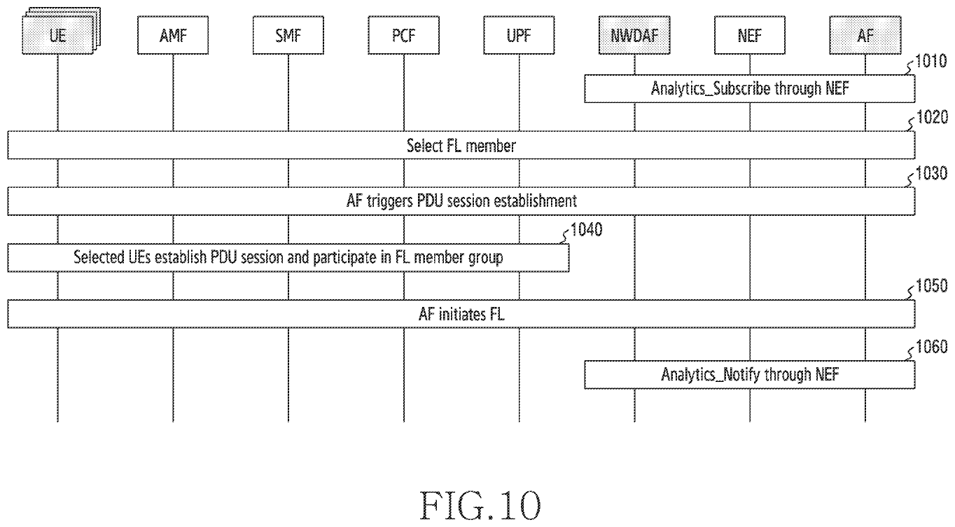

In operation 920, an application function (AF) may initiate federated learning and/or distributed AI/ML training. The detailed content of operation 910 and operation 920 described above will be described with reference to FIG. 10 below.

Hereinafter, specific operations (e.g., operation 930 to operation 960) of a local model training procedure may be described.

In operation 930, the multiple UEs participating in federated learning may transmit uplink (UL) data to the parameter server via a UPF. The uplink data may include a local weight for training data of each UE.

In operation 940, the parameter server may perform a gradient aggregation operation, based on the respective local weights received from the multiple UEs participating in federated learning.

In operation 950, the parameter server may transmit downlink (DL) data including a merged weight value obtained through gradient aggregation to the multiple UEs participating in federated learning.

In operation 960, each of the multiple UEs participating in federated learning may update a local model, based on the merged weight value obtained through gradient aggregation. Then, the multiple UEs participating in federated learning may transmit uplink data to the parameter server via the UPF. The uplink data may include local weight values updated according to the update of the local models.

In operation 970, the parameter server may update a global model, based on the updated local weight values received from the multiple UEs participating in federated learning.

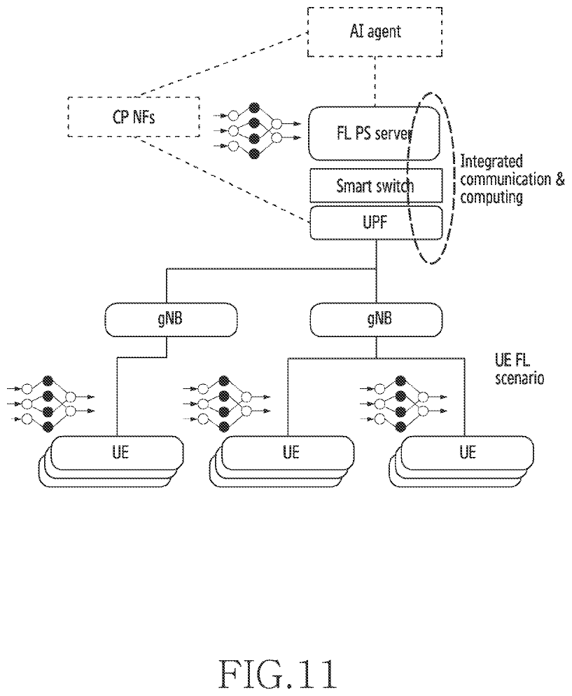

In operation 910 to operation 980 described above, signaling between the multiple UEs participating in federated learning and the parameter server may be performed through a base station (e.g., gNB), a network entity of a 5G system, and switches included between nodes (or network entities). The switches included between the nodes (or network entities) may not perform a separate calculation for local weights transmitted by the multiple UEs participating in federated learning in the process of transferring the local weights to the next layer. However, when switches are used, the operations of an AI/ML update procedure based on a parameter server may be reduced. Therefore, when switches are used, the time and signaling overhead required for performing an AI/ML update procedure may be reduced. Therefore, the following embodiments (e.g., FIG. 11 to FIG. 22) proposed in the disclosure may provide methods for reducing the operations of a local model training procedure based on a parameter server.

FIG. 10 illustrates a signal flow in a selection procedure for a UE group related to various embodiments of the disclosure.

Referring to FIG. 10, prerequisite operations (e.g., operation 910 and operation 920 in FIG. 9 described above) of a procedure for updating a local model may be specifically described.

In operation 1010, an AF may transmit a message (e.g., Analytics_Subscribe) for requesting an analytics service to an NWDAF via an NEF. Specifically, an application service provider (ASP) may request, from a 5G system, a quality of service (QoS) for federated learning traffic transmission of UEs which are to participate in federated learning. Then, the ASP may provide a list of the UEs which are to participate in federated learning and a QoS requirement to the 5G system. The AF may allocate a QoS flow to a PCF via the NEF, based on the QoS requirement received from the ASP, and request UE selection. In addition, the AF may also request the PCF, via the NEF, to update a QoS requirement and a list of UEs in a federated learning group.

In operation 1020, the 5G system may select UEs capable of participation in the federated learning group.

In operation 1030, the AF may trigger establishment of a PDU session. The AF may also request a UDM to generate, update, or remove a parameter for a federated learning service. The PCF may identify that a UE corresponding to a PDU session belongs to the federated learning group, via the UDM in a PDU session generation or modification procedure, and determine a QoS parameter according to a QoS requirement received from the UDM. A QoS flow having the same QoS parameter may be generated for each selected UE.

In operation 1040, the UEs selected as being capable of participation from the federated learning group may establish a PDU session, and participate in a federated learning member group.

In operation 1050, the AF may initiate federated learning.

In operation 1060, the NWDAF may transmit an analytics service notification message (e.g., Analytics_Notify) to the AF via the NEF as a response for the analytics service request.

FIG. 11 illustrates a structure of a federated learning scenario of UEs according to various embodiments of the disclosure.

FIG. 11 may show an embodiment of a UE federated learning scenario in which a gradient aggregation method for distributed AI/ML training proposed in the disclosure is applied to a mobile communication system (or wireless communication system). Multiple UEs which are to participate in federated learning may transmit pieces of training data for updating an AI/ML model to corresponding base stations (e.g., gNBs) providing a service. Each base station may transmit collected pieces of training data to a network entity (e.g., UPF) of a 5G system. For example, the UPF, NFs of another CP, and an AI agent may perform integrated communication and computing with an FL PS through a smart switch of the UPF, and the UPF may operate in an integrated communication and computing operation in conjunction with the NFs of the other CP and the AI agent.

The smart switch which may be included in the UPF may indicate a programmable switch unlike the P4 switch in FIG. 8 described above. The smart switch may refer to a switch capable of performing multiple calculations (e.g., including at least one of an arithmetic calculation or XOR) through programming. Therefore, all or some of the operations for updating an AI/ML model proposed in the disclosure may be performed in a smart switch rather than a parameter server.

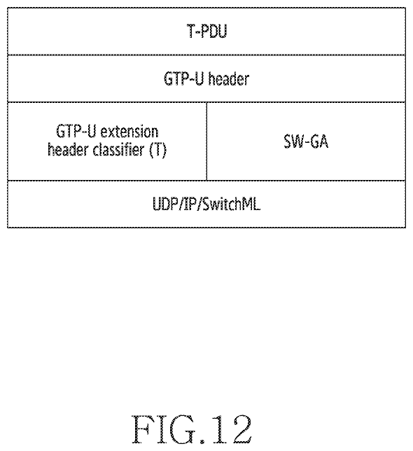

FIG. 12 illustrates a structure of a header including a weight value of each UE according to various embodiments of the disclosure.

Referring to FIG. 12, a structure of a GTP-U extension header which is usable in a procedure for accelerating an update of a distributed AI/ML model according to an embodiment of the disclosure may be described.

A GTP-U extension header may include at least one of a transport-PDU (T-PDU), a GTP-U header, a GTP-U extension header classifier (e.g., this is a classifier for distinguishing a gradient that is AI/ML data of a UE, and may be called T), a SW-GA, or user datagram protocol (UDP)/IP/SwitchML layer. The T-PDU may be a transport protocol data unit designated in octet 2, the SW-GA is a data format defined for gradient aggregation, and a base station (e.g., gNB) may move the gradient (e.g., diagram) of the UE to the SW-GA of the GTP extension header. The UDP is a transmission layer protocol that uses an internet protocol (IP), which is a network layer protocol, and SwitchML may be based on the UDP.

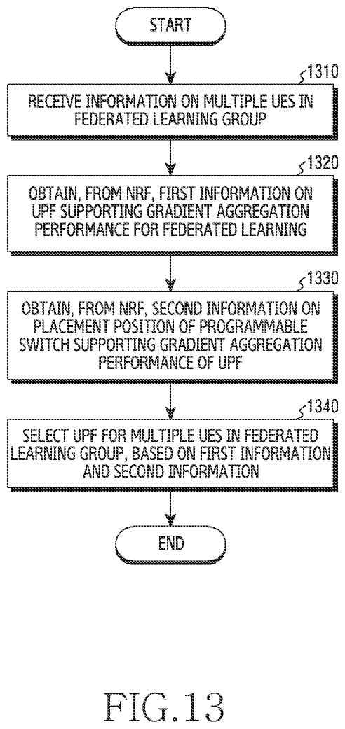

FIG. 13 illustrates an operation sequence of an SMF according to various embodiments of the disclosure.

Referring to FIG. 13, an operation sequence of an SMF in a method for accelerating an update of a distributed AI/ML model proposed in the disclosure may be described.

In operation 1310, an SMF may obtain information on multiple UEs in a federated learning group. The information on the multiple UEs in the federated learning group may include at least one of identifiers of the multiple UEs, allocation information on a QoS flow, or information on a post-processing capability of the multiple UEs. Information on a post-processing capability of a UE may be information indicating whether the UE is able to perform at least one of calculations of obtaining an average, a median, or a mode for a result value (e.g., aggregated weight) of gradient aggregation received from a smart switch included in a UPF.

In operation 1320, the SMF may obtain, from an NRF, first information on a UPF supporting a gradient aggregation performance for federated learning. The UPF supporting aggregation for federated learning may be a UPF including a smart switch. Therefore, the first information may include information on a UPF including a smart switch.

In operation 1330, the SMF may obtain, from the NRF, second information on a placement position of a smart switch supporting the gradient aggregation performance of the UPF. The placement position may be obtained from the NRF, directly obtained from the UPF, or obtained from another entity. The disclosure is not limited to the example.

As an embodiment, if the smart switch is positioned between a base station (e.g., gNB) and the UPF, local weight values transmitted by multiple UEs may be stored in an SW-GA of a GTP-U extension header by the base station (e.g., gNB). As an embodiment, if the smart switch is positioned between the UPF and a parameter server, local weight values transmitted by multiple UEs may be stored in a SwitchML header based on a UDP.

In operation 1340, the SMF may select a UPF for the multiple UEs in the federated learning group, based on the first information and the second information. As an embodiment, if the UPF supports aggregation, gradient aggregation may be performed in the UPF. As an embodiment, if the UPF does not support aggregation, gradient aggregation may be performed in the parameter server as described above with reference to FIG. 9. The SMF may select a UPF so that the multiple UEs in the federated learning group perform communication through one logical UPF, and may perform session management and QoS allocation of multiple UEs in multiple federated learning groups. An operation of the SMF is not limited to the above example.

As an example, if the multiple UEs have a post-processing capability, a result value (e.g., aggregated weight) of gradient aggregation in the UPF may be transmitted to the multiple UEs. The multiple UEs may perform a post-processing operation for the received result value (e.g., aggregated weight) of gradient aggregation. As an example, if the multiple UEs do not have a post-processing capability, a result value (e.g., aggregated weight) of gradient aggregation in the UPF may be transmitted to the parameter server. A post-processing operation for the result value (e.g., aggregated weight) of gradient aggregation may be performed in the parameter server.

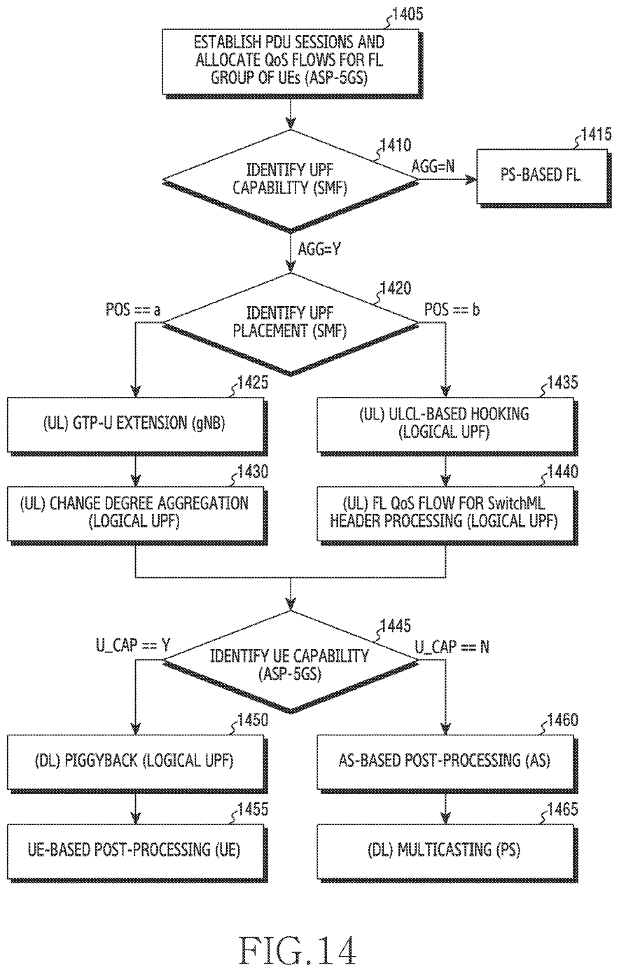

FIG. 14 illustrates a procedure for accelerating an update of artificial intelligence (AI)/machine learning (ML) according to various embodiments of the disclosure.

Referring to FIG. 14, an operation sequence of a 5G system in a method for accelerating an update of a distributed AI/ML model proposed in the disclosure may be described. The following operational stages may include a procedure for updating a local model.

In operation 1405, an ASP may provide a list of UEs which are to participate in federated learning and a QoS requirement to a 5G system. Information provided to the 5G system may further include information on a post-processing capability of a UE after a smart switch performs gradient aggregation. Information on a post-processing capability of a UE may be information indicating whether the UE is able to perform at least one of calculations of obtaining an average, a median, or a mode for a result value (e.g., aggregated weight) of gradient aggregation received from a smart switch included in a UPF. As described above, the information transmitted from the ASP to the 5G system may include at least one of a merged QoS request indicator (e.g., aggregated QoS request indicator), a list of UE addresses, a QoS requirement (and/or alternative requests), an identifier of a federated learning group, single-network slice selection assistance information (S-NSSAI), a date network name (DNN), and a post-processing indicator (e.g., U_CAP) of a UE. In the 5G system, PDU sessions for UEs capable of participation in the federated learning group may be established, and QoS flows for the UEs capable of participation in the federated learning group may be allocated.

In operation 1410, an SMF may identify a UPF capability. The UPF capability may indicate whether a UPF is capable of including a smart switch supporting gradient aggregation. Whether the UPF includes a smart switch may be determined based on information received by the SMF from an NRF. The information received by the SMF from the NRF may include at least one of S-NSSAI, a DNN, information indicating the UPF capability, or information on the placement of a smart switch supporting gradient aggregation. Therefore, the SMF may select a UPF, based on an identifier (e.g., aggregation capability, AGG) relating to the UPF capability and an identifier (e.g., POS) relating to the placement of a smart switch. That is, the SMF may support UPF provisioning for federated learning.

In operation 1415, if a UPF does not include a smart switch supporting gradient aggregation (e.g., an AGG value is N), federated learning based on a parameter server may be performed. In this case, local weight values transmitted from the UEs of the federated learning group may be transmitted to the parameter server, and a gradient aggregation operation may be performed in the parameter server. Therefore, the operation of operation 1430 may include the same or similar operations with the same intent as the local model update procedure (e.g., operation 920 to operation 960) in FIG. 9 described above.

In operation 1420, if a UPF includes a smart switch supporting gradient aggregation (e.g., an AGG value is Y), the SMF may select the UPF including a smart switch supporting gradient aggregation. The UPF including the smart switch supporting gradient aggregation may imply that the smart switch is positioned between the UPF and the server or between the UPF and a gNB as described above. In this case, the SMF may configure the UE group capable of participating in federated learning to be mapped to the same logical UPF. Then, the SMF may identify the placement of a smart switch supporting gradient aggregation, based on the information (e.g., information on the placement of a smart switch supporting gradient aggregation) received from the NRF.

However, the AGG value may be indicated by a value of 1 bit (e.g., 0 or 1) or more according to whether the smart switch is included, and is not necessarily limited to Y or N.

In operation 1425, if the smart switch is positioned between a base station (e.g., gNB) and the UPF (e.g., a POS value is a), the base station (e.g., gNB) may include gradients of the UEs in the federated learning group in a GTP-U extension header (e.g., SW-GA) and transmit the header. According to an embodiment of the disclosure, the placement of a smart switch may indicate a placement inside a UPF, or a placement at a separate node connected to a UPF.

In operation 1430, the UPF may aggregate the gradients of the UEs in the federated learning group included (or stored) in the GTP-U extension header (e.g., SW-GA). Specifically, gradient aggregation may be performed in the smart switch included in the UPF. The gradient aggregation may include at least one calculation of an arithmetic calculation or XOR for the gradients. In this case, a method in which the gradients (e.g., the gradients received from distributed workers or the UEs) included in the GTP-U extension header are merged through gradient aggregation on the smart switch may be called a streaming manner. For example, the smart switch may perform an addition calculation (G1+G2) for respective gradients (G1 and G2) received from a first UE and a second UE in the federated learning group. Then, the smart switch may transmit the calculated value (G1+G2) to each UE or the parameter server according to whether the UE has a post-processing capability. Hereinafter, in embodiments of the disclosure, a gradient aggregation operation (or calculation) performed by the smart switch may be performed in a streaming manner.

In operation 1435, if the smart switch is positioned between the UPF and the parameter server (e.g., a POS value is b), the UPF may perform a hooking operation, based on an uplink classifier (ULCL). An uplink classifier (ULCL) function (e.g., a hooking operation based on the ULCL) of the UPF may be a function enabling traffic matching a traffic filter provided by the SMF to be redirected to an AF such as multi-access edge computing (MEC), and the ULCL may be controlled by the SMF via an N4 interface. According to an embodiment of the disclosure, the placement of a smart switch may indicate a placement inside a UPF, or a placement at a separate node connected to a UPF.

In operation 1440, the UPF may perform gradient aggregation, based on a SwitchML header of a QoS flow for federated learning. Specifically, since GTP-U decapsulation (dacap.) may be performed in the UPF, when gradients are included in a GTP-U header, it may be difficult to identify the gradients (or perform gradient aggregation) in the smart switch. Therefore, when the smart switch is positioned between the UPF and the parameter server, gradients may be included (or stored) in a SwitchML header unlike operation 1430. The gradient aggregation may include at least one calculation of an arithmetic calculation or XOR for the gradients. In this case, the gradient aggregation may be performed for the gradients (e.g., the gradients received from distributed workers or the UEs) included in the SwitchML header on the smart switch in a streaming manner.

However, the POS value may be indicated by a value of 1 bit (e.g., 0 or 1) or more according to the placement of the smart switch, and is not necessarily limited to a or b.

In operation 1445, the SG system may identify a post-processing capability of, for gradient aggregation, a UE in the federated learning group, based on the information (e.g., U_CAP) received from the ASP in operation 1405.

In operation 1450, if a UE in the federated learning group has a post-processing capability for gradient aggregation (e.g., a U_CAP value is Y), the smart switch may perform gradient aggregation and then transmit a result value (e.g., an aggregated weight) to the UEs in the federated learning group through piggybacking in a multicasting manner. The result value may be included in downlink data.

In operation 1455, the UEs in the federated learning group may perform a post-processing operation for the result value of gradient aggregation received from the smart switch included in the UPF. For example, the UEs in the federated learning group may perform at least one of calculations of obtaining an average, a median, or a mode for the result value of gradient aggregation by using a resource (e.g., a neural processing unit (NPU) or a central processing unit (CPU)) in the UEs.

In operation 1460, if a UE in the federated learning group does not have a post-processing capability for gradient aggregation (e.g., a U_CAP value is N), the smart switch may perform gradient aggregation and then transmit a result value (e.g., an aggregated weight) to the parameter server. Then, the parameter server may perform a post-processing operation for the result value. For example, the parameter server may perform at least one of calculations of obtaining an average, a median, or a mode for the result value of gradient aggregation.

In operation 1465, the parameter server perform a post-processing operation for the result value of gradient aggregation and then may transmit corresponding information to the UEs in the federated learning group in a multicasting manner.

However, the U_CAP value may be indicated by a value of 1 bit (e.g., 0 or 1) or more according to the capability of the UEs in the federated learning group, and is not necessarily limited to Y or N.

Each of the UEs in the federated learning group may update a local model, based on a value obtained through post-processing in operation 1455 or operation 1465 described above. The UEs in the federated learning group may transmit updated local weight values to the parameter server to enable the parameter server to update a global model.

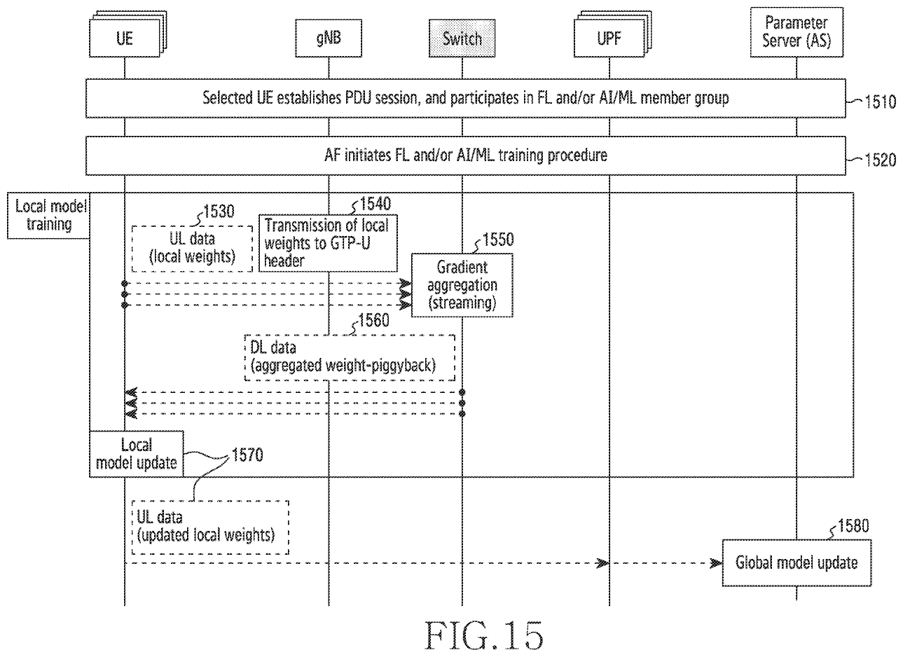

FIG. 15 illustrates a signal flow for supporting acceleration of an AI/ML update according to various embodiments of the disclosure.

Referring to FIG. 15, a signal flow of the case where, in the operation sequence according to FIG. 14 described above, the UPF includes a smart switch supporting gradient aggregation (e.g., AGG=Y), the smart switch is positioned between the base station (e.g., gNB) and the UPF (e.g., POS=a), and the UEs in the federated learning group have a post-processing capability (e.g., U_CAP=Y) may be described.

In operation 1510, PDU sessions with UEs which are to participate in federated learning may be established by an SMF. In addition, the selected UEs may participate in a federated learning and/or distributed AI/ML member group.

In operation 1520, an application function (AF) may initiate federated learning and/or distributed AI/ML training.

In operation 1530, the UEs in a federated learning group may transmit uplink data including respective local weight values thereof to a UPF via a base station (e.g., gNB).

In operation 1540, with respect to the uplink data transmitted to the UPF, the base station (e.g., gNB) may move gradients of the UEs in the federated learning group to a GTP-U extension header (e.g., SW-GA).

In operation 1550, a smart switch included in the UPF may aggregate (in a streaming manner) the gradients received from the UEs in the federated learning group. Specifically, the smart switch included in the UPF may be positioned between the UPF and the base station (e.g., gNB). Therefore, the smart switch may aggregate the gradients stored in GTP-U (e.g., SW-GA) by the base station (e.g., gNB) before decapsulation of the GTP-U extension header is performed in the UPF. The smart switch included in the UPF may perform a calculation including at least one of an arithmetic calculation or XOR for the gradients.

In operation 1560, the smart switch included in the UPF may transmit downlink data including a result value (e.g., an aggregated weight) of gradient aggregation to the UEs in the federated learning group through piggybacking in a multicasting manner.

In operation 1570, each of the UEs in the federated learning group may update a local model, based on the result value (e.g., an aggregated weight) of gradient aggregation received from the smart switch included in the UPF. Specifically, the UEs in the federated learning group may perform a post-processing operation for the result value of gradient aggregation received from the smart switch included in the UPF. For example, the UEs in the federated learning group may perform at least one of calculations of obtaining an average, a median, or a mode for the result value of gradient aggregation by using a resource (e.g., a NPU or a CPU) in the UEs. Then, the UEs in the federated learning group may transmit uplink data including updated local weight values to a parameter server to update a global model.

In operation 1580, the parameter server may update the global model, based on the updated local weight values received from the UEs in the federated learning group.

The method of FIG. 15 described above may reduce network volume and the computing resource consumption at the application server compared to the case in which gradient aggregation is performed in the parameter server (e.g., the embodiment of FIG. 9 described above). In addition, compared to the case in which gradient aggregation is performed in the parameter server, the update speed of the AI/ML model may be improved, and it may be advantageous in that AI/ML gradient data is accessible in a path through which a UP packet passes.

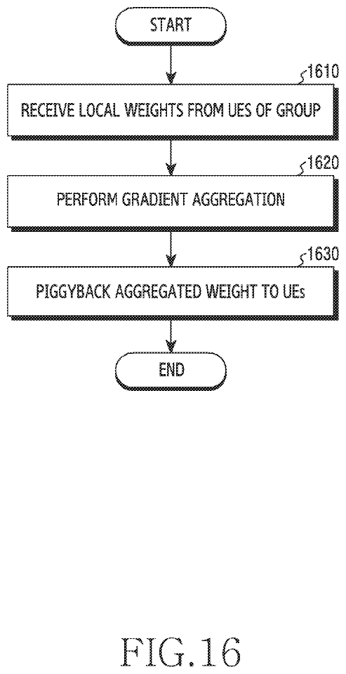

FIG. 16 illustrates an operation sequence of a smart switch for supporting acceleration of an AI/ML update according to various embodiments of the disclosure.

Referring to FIG. 16, an operation sequence of the smart switch included in the UPF described above with reference to FIG. 15 may be described.

In operation 1610, a smart switch included in a UPF may receive uplink data including respective local weight values of UEs in a federated learning group from the UEs.

In operation 1620, the smart switch included in the UPF may aggregate gradients received from the UEs in the federated learning group. The smart switch included in the UPF may be positioned between the UPF and a base station (e.g., gNB). Therefore, the smart switch may aggregate gradients stored in GTP-U (e.g., SW-GA) by the base station (e.g., gNB) before decapsulation of the GTP-U extension header is performed in the UPF. The smart switch included in the UPF may perform a calculation including at least one of an arithmetic calculation or XOR for the gradients.

In operation 1630, the smart switch included in the UPF may transmit downlink data including a result value (e.g., an aggregated weight) of gradient aggregation to the UEs in the federated learning group through piggybacking in a multicasting manner A local model may be updated based on the result value (e.g., aggregated weight) of gradient aggregation.

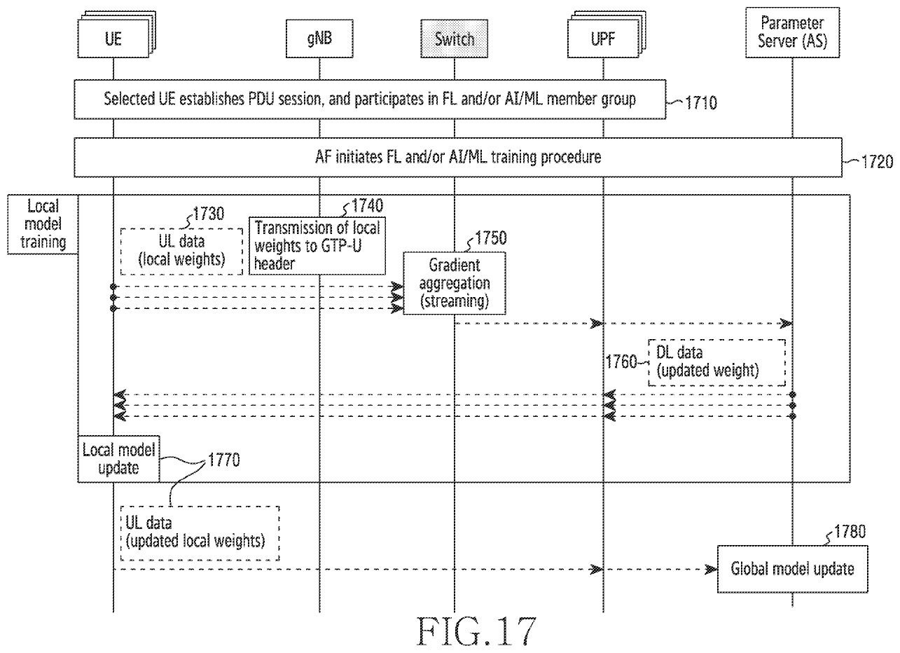

FIG. 17 illustrates a signal flow for supporting acceleration of an AI/ML update according to various embodiments of the disclosure.

Referring to FIG. 17, a signal flow of the case where, in the operation sequence according to FIG. 14 described above, the UPF includes a smart switch supporting gradient aggregation (e.g., AGG=Y), the smart switch is positioned between the base station (e.g., gNB) and the UPF (e.g., POS=a), and the UEs in the federated learning group do not have a post-processing capability (e.g., U_CAP=N) may be described.

In operation 1710, UEs which are to participate in federated learning may be selected by a parameter server, and the selected UEs may establish a PDU session through an SMF. In addition, the selected UEs may participate in a federated learning and/or distributed AI/ML member group.

In operation 1720, an application function (AF) may initiate federated learning and/or distributed AI/ML training.

In operation 1730, the UEs in a federated learning group may transmit uplink data including respective local weight values thereof to a UPF via a base station (e.g., gNB).

In operation 1740, with respect to the uplink data transmitted to the UPF, the base station (e.g., gNB) may move gradients of the UEs in the federated learning group to a GTP-U extension header (e.g., SW-GA),

In operation 1750, a smart switch included in the UPF may aggregate (in a streaming manner) the gradients received from the UEs in the federated learning group. Specifically, a smart switch included in the UPF may be positioned between the UPF and the base station (e.g., gNB). Therefore, the smart switch may aggregate the gradients stored in GTP-U (e.g., SW-GA) by the base station (e.g., gNB) before decapsulation of the GTP-U extension header is performed in the UPF. The smart switch included in the UPF may perform a calculation including at least one of an arithmetic calculation or XOR for the gradients. The smart switch included in the UPF may transmit a result value (e.g., aggregated weight) of gradient aggregation to the parameter server via the UPF.

In operation 1760, the parameter server may update local models, based on the result value (e.g., an aggregated weight) of gradient aggregation received from the smart switch included in the UPF. Specifically, the parameter server may perform a post-processing operation for the result value of gradient aggregation received from the smart switch included in the UPF. For example, the parameter server may perform at least one of calculations of obtaining an average, a median, or a mode for the result value of gradient aggregation. Then, the parameter server may transmit downlink data including updated weight values (e.g., updated weights) to the UEs in the federated learning group via the UPF in a multicasting manner so as to update the local models. As described above, whether the parameter server performs post-processing may be determined based on whether the UE is able to perform post-processing, or determined by another entity, such as the UPF, the SMF, or the AF, and the disclosure is not limited to the above example.

In operation 1770, the UEs in the federated learning group may update the local models, based on the updated weight values (e.g., updated weights) received from the parameter server. Then, the UEs in the federated learning group may transmit uplink data including the updated local weight values to the parameter server to update a global model.

In operation 1780, the parameter server may update the global model, based on the updated local weight values received from the UEs in the federated learning group.

The method of FIG. 17 described above may correspond to an embodiment in which when at least one of the UEs in the federated learning group does not have a post-processing capability, a post-processing operation for the result value of gradient aggregation is performed in the parameter server.

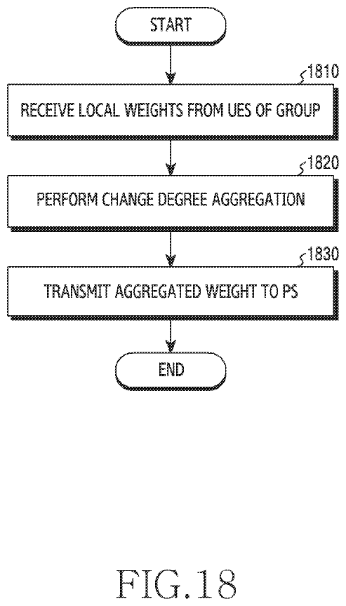

FIG. 18 illustrates an operation sequence of a smart switch for supporting acceleration of an AI/ML update according to various embodiments of the disclosure.

Referring to FIG. 18, an operation sequence of the smart switch included in the UPF described above with reference to FIG. 17 may be described.

In operation 1810, a smart switch included in a UPF may receive uplink data including respective local weight values of UEs in a federated learning group from the UEs.

In operation 1820, the smart switch included in the UPF may aggregate gradients received from the UEs in the federated learning group. The smart switch included in the UPF may be positioned between the UPF and a base station (e.g., gNB). Therefore, the smart switch may aggregate gradients stored in GTP-U (e.g., SW-GA) by the base station (e.g., gNB) before decapsulation of a GTP-U extension header is performed in the UPF. The smart switch included in the UPF may perform a calculation including at least one of an arithmetic calculation or XOR for the gradients.

In operation 1830, the smart switch included in the UPF may transmit a result value (e.g., aggregated weight) of gradient aggregation to a parameter server. Therefore, a post-processing operation for the result value (e.g., aggregated weight) of gradient aggregation may be performed in the parameter server.

As described above, if the UEs in the federated learning group are UEs incapable of post-processing, a result value of gradient aggregation may be transmitted to the parameter server, and post-processing may be performed in the parameter server. The disclosure is not limited to the above example, and whether post-processing is performed in the parameter server may also be determined by another entity, such as the UPF, an SMF, or an AF.

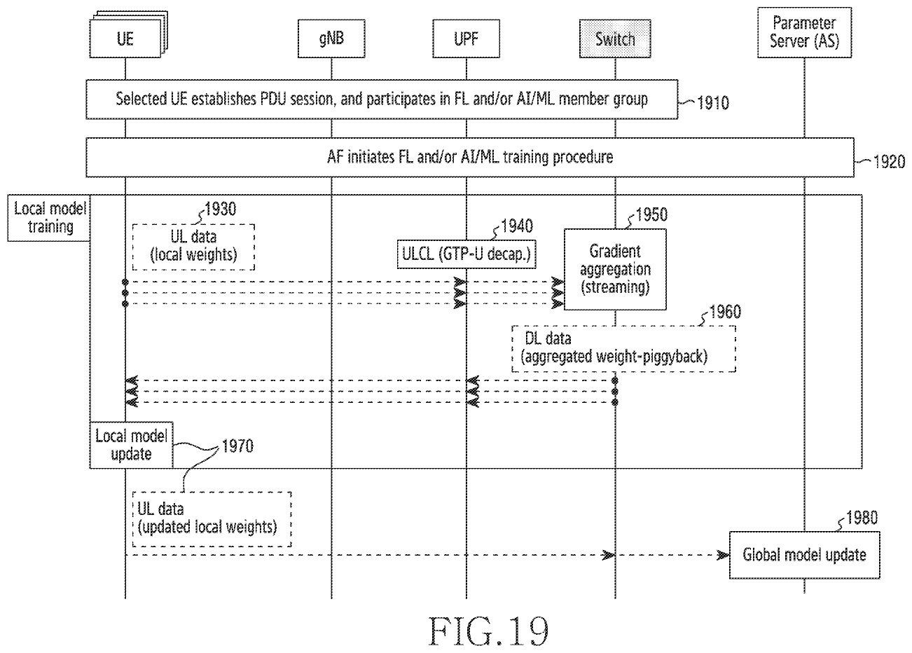

FIG. 19 illustrates a signal flow for supporting acceleration of an AI/ML update according to various embodiments of the disclosure.

Referring to FIG. 19, a signal flow of the case where, in the operation sequence according to FIG. 14 described above, the UPF includes a smart switch supporting gradient aggregation (e.g., AGG=Y), the smart switch is positioned between the UPF and the parameter server (e.g., POS=b), and the UEs in the federated learning group have a post-processing capability (e.g., U_CAP=Y) may be described.

In operation 1910, UEs which are to participate in federated learning may be selected by a parameter server, and the selected UEs may establish a PDU session through an SMF. In addition, the selected UEs may participate in a federated learning and/or distributed AI/ML member group.

In operation 1920, an application function (AF) may initiate federated learning and/or distributed AI/ML training.

In operation 1930, the UEs in a federated learning group may transmit uplink data including respective local weight values thereof to a UPF. A base station (e.g., gNB) may not move gradients of the UEs in the federated learning group included in the uplink data to a GTP-U extension header (e.g., SW-GA).

In operation 1940, the UPF may perform a ULCL-based hooking operation for the gradients received from the UEs in the federated learning group and then transmit the hooked gradients to a smart switch.

In operation 1950, the smart switch included in the UPF may aggregate (e.g., in a streaming manner) the gradients received from the UPF. Specifically, the smart switch included in the UPF may perform gradient aggregation, based on a SwitchML header of a QoS flow for federated learning. Specifically, since GTP-U decapsulation (dacap.) may be performed in the UPF, when gradients are included in a GTP-U header, it may be difficult to identify the gradients in the smart switch. Therefore, when the smart switch is positioned between the UPF and the parameter server, gradients may be included in a SwitchML header. The gradient aggregation may include at least one calculation of an arithmetic calculation or XOR for the gradients.

In operation 1960, the smart switch included in the UPF may transmit downlink data including a result value (e.g., an aggregated weight) of gradient aggregation to the UEs in the federated learning group through piggybacking in a multicasting manner.

In operation 1970, each of the UEs in the federated learning group may update a local model, based on the result value (e.g., an aggregated weight) of gradient aggregation received from the smart switch included in the UPF. Specifically, the UEs in the federated learning group may perform a post-processing operation for the result value of gradient aggregation received from the smart switch included in the UPF. For example, the UEs in the federated learning group may perform at least one of calculations of obtaining an average, a median, or a mode for the result value of gradient aggregation by using a resource (e.g., a NPU or a CPU) in the UEs. Then, the UEs in the federated learning group may transmit uplink data including updated local weight values to the parameter server to update a global model.

In operation 1980, the parameter server may update the global model, based on the updated local weight values received from the UEs in the federated learning group.

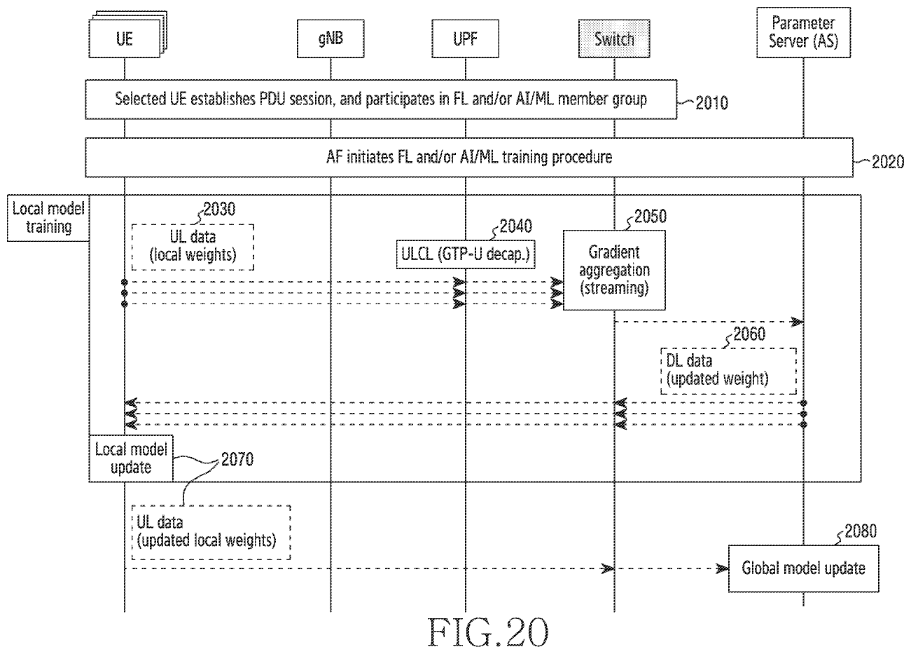

FIG. 20 illustrates a signal flow for supporting acceleration of an AI/ML update according to various embodiments of the disclosure.

Referring to FIG. 20, a signal flow of the case where, in the operation sequence according to FIG. 14 described above, the UPF includes a smart switch supporting gradient aggregation (e.g., AGG=Y), the smart switch is positioned between the UPF and the parameter server (e.g., POS=b), and the UEs in the federated learning group do not have a post-processing capability (e.g., U_CAP=N) may be described.

In operation 2010, UEs which are to participate in federated learning may be selected by a parameter server, and the selected UEs may establish a PDU session through an SMF. In addition, the selected UEs may participate in a federated learning and/or distributed AI/ML member group.

In operation 2020, an application function (AF) may initiate federated learning and/or distributed AI/ML training.

In operation 2030, the UEs in a federated learning group may transmit uplink data including respective local weight values thereof to a UPF. A base station (e.g., gNB) may not move gradients of the UEs in the federated learning group included in the uplink data to a GTP-U extension header (e.g., SW-GA).

In operation 2040, the UPF may perform a ULCL-based hooking operation for the gradients received from the UEs in the federated learning group and then transmit the hooked gradients to a smart switch.

In operation 2050, the smart switch included in the UPF may aggregate (e.g., in a streaming manner) the gradients received from the UPF. Specifically, the smart switch included in the UPF may perform gradient aggregation, based on a SwitchML header of a QoS flow for federated learning. Specifically, since GTP-U decapsulation (dacap.) may be performed in the UPF, when gradients are included in a GTP-U header, it may be difficult to identify the gradients in the smart switch. Therefore, when the smart switch is positioned between the UPF and the parameter server, gradients may be included in a SwitchML header. The gradient aggregation may include at least one calculation of an arithmetic calculation or XOR for the gradients. Then, the smart switch included in the UPF may transmit a result value (e.g., aggregated weight) of performing gradient aggregation to the parameter server.

In operation 2060, the parameter server may update local models, based on the result value (e.g., an aggregated weight) of gradient aggregation received from the smart switch included in the UPF. Specifically, the parameter server may perform a post-processing operation for the result value of gradient aggregation received from the smart switch included in the UPF. For example, the parameter server may perform at least one of calculations of obtaining an average, a median, or a mode for the result value of gradient aggregation. Then, the parameter server may transmit downlink data including updated weight values (e.g., updated weights) to the UEs in the federated learning group via the UPF in a multicasting manner so as to update the local models.

In operation 2070, the UEs in the federated learning group may update the local models, based on the updated weight values (e.g., updated weights) received from the parameter server. Then, the UEs in the federated learning group may transmit uplink data including updated local weight values to the parameter server to update a global model.

In operation 2080, the parameter server may update the global model, based on the updated local weight values received from the UEs in the federated learning group.

An operation method of a session management function (SMF) for supporting federated learning in a wireless communication system according to an embodiment of the disclosure as described above may include obtaining information on multiple terminals in a federated learning group, obtaining, from a network repository function (NRF), first information on a user plane function (UPF) supporting a gradient aggregation performance for federated learning, obtaining, from the NRF, second information on a placement position of a programmable switch supporting the gradient aggregation performance of the UPF, and selecting a UPF for the multiple terminals in the federated learning group, based on at least one of the first information and the second information, wherein in case that the gradient aggregation performance is supported, gradient aggregation is performed in the UPF, wherein in case that the gradient aggregation performance is not supported, the gradient aggregation is performed in a parameter server (PS), and wherein the gradient aggregation includes performing at least one of an arithmetic calculation or an exclusive OR (XOR) calculation for gradients of the multiple terminals.

According to an embodiment, the information on the multiple terminals in the federated learning group may include at least one of identifiers of the multiple terminals, allocation information on a quality-of-service (QoS) flow, or information on a post-processing capability of the multiple terminals, and the post-processing capability may relate to whether at least one of calculations of obtaining an average, a median, or a mode is performed for a result value of the gradient aggregation,

According to an embodiment, in case that the multiple terminals have the post-processing capability, the result value of the gradient aggregation may be transmitted from the UPF to the multiple terminals, and a post-processing operation for the result value of the gradient aggregation may be performed in the multiple terminals.

According to an embodiment, in case that the multiple terminals do not have the post-processing capability, the result value of the gradient aggregation may be transmitted from the UPF to the PS, and a post-processing operation for the result value of the gradient aggregation may be performed in the PS.

According to an embodiment, in case that the programmable switch is positioned between a base station and the UPF, the gradients may be stored in a general packet radio service (GPRS)-tunneling protocol (GTP)-U extension header, and in case that the programmable switch is positioned between the UPF and the PS, the gradients may be stored in a SwitchML header.

An operation method of a user plane function (UPF) for supporting federated learning in a wireless communication system according to an embodiment of the disclosure as described above may include receiving a control message for multiple terminals in a federated learning group from a session management function (SMF), receiving gradients from the multiple terminals, based on the control message, performing aggregation for the gradients, based on whether aggregation is supported, and performing transmission to a parameter server (PS) or the multiple terminals, based on a post-processing capability of the multiple terminals, wherein gradient aggregation includes performing at least one of an arithmetic calculation or an exclusive OR (XOR) calculation for the gradients of the multiple terminals.

According to an embodiment, in the method, the control message may include at least one of identifiers of the multiple terminals, allocation information on a quality-of-service (QoS) flow, or information on a post-processing capability of the multiple terminals.

According to an embodiment, information on the post-processing capability may be obtained from a network repository function (NRF), and wherein the post-processing capability may relate to whether at least one of calculations of obtaining an average, a median, or a mode is performed for a result value of the gradient aggregation.

According to an embodiment, whether the aggregation is supported may be determined based on a programmable switch of the UPF, in case that the programmable switch is positioned between a base station and the UPF, the gradients may be stored in a general packet radio service (GPRS)-tunneling protocol (GTP)-U extension header, and in case that the programmable switch is positioned between the UPF and the PS, the gradients may be stored in a SwitchML header.

According to an embodiment, in case that the multiple terminals have the post-processing capability, the result value of the gradient aggregation may be transmitted from the UPF to the multiple terminals, and a post-processing operation for the result value of the gradient aggregation may be performed in the multiple terminals. In case that the multiple terminals do not have the post-processing capability, the result value of the gradient aggregation may be transmitted from the UPF to the PS, and a post-processing operation for the result value of the gradient aggregation may be performed in the PS.

A session management function (SMF) for supporting federated learning in a wireless communication system according to an embodiment of the disclosure as described above may include at least one transceiver, and at least one processor operably coupled to the at least one transceiver, wherein the at least one processor is configured to obtain information on multiple terminals in a federated learning group, obtain, from a network repository function (NRF), first information on a user plane function (UPF) supporting a gradient aggregation performance for federated learning, obtain, from the NRF, second information on a placement position of a programmable switch supporting the gradient aggregation performance of the UPF, and select a UPF for the multiple terminals in the federated learning group, based on at least one of the first information and the second information, wherein in case that the gradient aggregation performance is supported, gradient aggregation is performed in the UPF, and wherein in case that the gradient aggregation performance is not supported, the gradient aggregation is performed in a parameter server (PS), and wherein the gradient aggregation includes performing at least one of an arithmetic calculation or an exclusive OR (XOR) calculation for gradients of the multiple terminals.

According to an embodiment, the information on the multiple terminals in the federated learning group may include at least one of identifiers of the multiple terminals, allocation information on a quality-of-service (QoS) flow, or information on a post-processing capability of the multiple terminals, and the post-processing capability may relate to whether at least one of calculations of obtaining an average, a median, or a mode is performed for a result value of the gradient aggregation.

According to an embodiment, in case that the multiple terminals have the post-processing capability, the result value of the gradient aggregation may be transmitted from the UPF to the multiple terminals, and a post-processing operation for the result value of the gradient aggregation may be performed in the multiple terminals.

According to an embodiment, in case that the multiple terminals do not have the post-processing capability, the result value of the gradient aggregation may be transmitted from the UPF to the PS, and a post-processing operation for the result value of the gradient aggregation may be performed in the PS.

According to an embodiment, in case that the programmable switch is positioned between a base station and the UPF, the gradients may be stored in a general packet radio service (GPRS)-tunneling protocol (GTP)-U extension header, and in case that the programmable switch is positioned between the UPF and the PS, the gradients may be stored in a SwitchML header.

A user plane function (UPF) for supporting federated learning in a wireless communication system according to an embodiment of the disclosure as described above may include at least one transceiver, and at least one processor operably coupled to the at least one transceiver, wherein the at least one processor is configured to receive a control message for multiple terminals in a federated learning group from a session management function (SMF), receive gradients from the multiple terminals, based on the control message, perform aggregation for the gradients, based on whether aggregation is supported, and perform transmission to a parameter server (PS) or the multiple terminals, based on a post-processing capability of the multiple terminals, and wherein gradient aggregation includes performing at least one of an arithmetic calculation or an exclusive OR (XOR) calculation for the gradients of the multiple terminals.

According to an embodiment, the control message may include at least one of identifiers of the multiple terminals, allocation information on a quality-of-service (QoS) flow, or information on a post-processing capability of the multiple terminals.

According to an embodiment, information on the post-processing capability may be obtained from a network repository function (NRF), and wherein the post-processing capability may relate to whether at least one of calculations of obtaining an average, a median, or a mode is performed for a result value of the gradient aggregation

According to an embodiment, whether the aggregation is supported may be determined based on a programmable switch of the UPF, in case that the programmable switch is positioned between a base station and the UPF, the gradients may be stored in a general packet radio service (GPRS)-tunneling protocol (GTP)-U extension header, and in case that the programmable switch is positioned between the UPF and the PS, the gradients may be stored in a SwitchML header.

According to an embodiment, in case that the multiple terminals have the post-processing capability, the result value of the gradient aggregation may be transmitted from the UPF to the multiple terminals, and a post-processing operation for the result value of the gradient aggregation may be performed in the multiple terminals, and in case that the multiple terminals do not have the post-processing capability, the result value of the gradient aggregation may be transmitted from the UPF to the PS, and a post-processing operation for the result value of the gradient aggregation may be performed in the PS.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Altematively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1. An operation method of a session management function (SMF) entity for supporting federated learning in a wireless communication system, the method comprising:
obtaining information on multiple terminals in a federated learning group;
obtaining, from a network repository function (NRF) entity, first information on a user plane function (UPF) entity supporting a gradient aggregation performance for federated learning;
obtaining, from the NRF entity, second information on a placement position of a programmable switch supporting the gradient aggregation performance of the UPF entity; and
selecting the UPF entity for the multiple terminals in the federated learning group, based on at least one of the first information and the second information,
wherein, in case that the gradient aggregation performance is supported, gradient aggregation is performed in the UPF entity,
wherein, in case that the gradient aggregation performance is not supported, the gradient aggregation is performed in a parameter server (PS), and
wherein the gradient aggregation comprises performing at least one of an arithmetic calculation or an exclusive OR (XOR) calculation for gradients of the multiple terminals.

2. The method of claim 1, wherein the information on the multiple terminals in the federated learning group comprises at least one of identifiers of the multiple terminals, allocation information on a quality-of-service (QoS) flow, or information on a post-processing capability of the multiple terminals, and
wherein the post-processing capability comprises whether the multiple terminals perform at least one of calculations for obtaining an average, a median, or a mode for a result value of the gradient aggregation.

3. The method of claim 2, wherein, in case that the multiple terminals have the post-processing capability, the result value of the gradient aggregation is transmitted from the UPF entity to the multiple terminals, and
wherein a post-processing operation for the result value of the gradient aggregation is performed in the multiple terminals.

4. The method of claim 2, wherein, in case that the multiple terminals do not have the post-processing capability, the result value of the gradient aggregation is transmitted from the UPF entity to the PS, and
wherein a post-processing operation for the result value of the gradient aggregation is performed in the PS.

5. An operation method of a user plane function (UPF) entity for supporting federated learning in a wireless communication system, the method comprising:
receiving a control message for multiple terminals in a federated learning group from a session management function (SMF) entity;
receiving gradients from the multiple terminals, based on the control message;
performing aggregation for the gradients, based on whether aggregation is supported; and
performing transmission to a parameter server (PS) or the multiple terminals, based on a post-processing capability of the multiple terminals,
wherein gradient aggregation comprises performing at least one of an arithmetic calculation or an exclusive OR (XOR) calculation for the gradients of the multiple terminals.

6. The method of claim 5, wherein the control message comprises at least one of identifiers of the multiple terminals, allocation information on a quality-of-service (QoS) flow, or information on the post-processing capability of the multiple terminals.

7. The method of claim 5, wherein information on the post-processing capability is obtained from a network repository function (NRF) entity, and
wherein the post-processing capability comprises whether the multiple terminals perform at least one of calculations for obtaining an average, a median, or a mode for a result value of the gradient aggregation.

8. The method of claim 5, wherein whether the aggregation is supported is determined based on a programmable switch of the UPF entity,
wherein, in case that the programmable switch is positioned between a base station and the UPF entity, the gradients are stored in a general packet radio service (GPRS)-tunneling protocol (GTP)-U extension header, and
wherein, in case that the programmable switch is positioned between the UPF entity and the PS, the gradients are stored in a SwitchML header.

9. A session management function (SMF) entity for supporting federated learning in a wireless communication system, the SMF entity comprising:
at least one transceiver; and
at least one processor coupled to the at least one transceiver,
wherein the at least one processor is configured to:
obtain information on multiple terminals in a federated learning group;
obtain, from a network repository function (NRF) entity, first information on a user plane function (UPF) entity supporting a gradient aggregation performance for federated learning,
obtain, from the NRF entity, second information on a placement position of a programmable switch supporting the gradient aggregation performance of the UPF entity; and
select the UPF entity for the multiple terminals in the federated learning group, based on at least one of the first information and the second information,
wherein, in case that the gradient aggregation performance is supported, gradient aggregation is performed in the UPF entity,
wherein, in case that the gradient aggregation performance is not supported, the gradient aggregation is performed in a parameter server (PS), and
wherein the gradient aggregation comprises performing at least one of an arithmetic calculation or an exclusive OR (XOR) calculation for gradients of the multiple terminals.

10. The SMF entity of claim 9, wherein the information on the multiple terminals in the federated learning group comprises at least one of identifiers of the multiple terminals, allocation information on a quality-of-service (QoS) flow, or information on a post-processing capability of the multiple terminals, and
wherein the post-processing capability comprises whether the multiple terminals perform at least one of calculations for obtaining an average, a median, or a mode for a result value of the gradient aggregation.

11. The SMF entity of claim 10, wherein, in case that the multiple terminals have the post-processing capability, the result value of the gradient aggregation is transmitted from the UPF entity to the multiple terminals, and
wherein a post-processing operation for the result value of the gradient aggregation is performed in the multiple terminals.

12. The SMF entity of claim 10, wherein, in case that the multiple terminals do not have the post-processing capability, the result value of the gradient aggregation is transmitted from the UPF entity to the PS, and
wherein a post-processing operation for the result value of the gradient aggregation is performed in the PS.

13. A user plane function (UPF) entity for supporting federated learning in a wireless communication system, the UPF entity comprising:
at least one transceiver; and
at least one processor coupled to the at least one transceiver,
wherein the at least one processor is configured to:
receive a control message for multiple terminals in a federated learning group from a session management function (SMF) entity;
receive gradients from the multiple terminals, based on the control message;
perform aggregation for the gradients, based on whether aggregation is supported; and
perform transmission to a parameter server (PS) or the multiple terminals, based on a post-processing capability of the multiple terminals, and
wherein gradient aggregation comprises performing at least one of an arithmetic calculation or an exclusive OR (XOR) calculation for the gradients of the multiple terminals.

14. The UPF entity of claim 13, wherein the control message comprises at least one of identifiers of the multiple terminals, allocation information on a quality-of-service (QoS) flow, or information on the post-processing capability of the multiple terminals.

15. The UPF entity of claim 13, wherein information on the post-processing capability is obtained from a network repository function (NRF) entity, and
wherein the post-processing capability comprises whether the multiple terminals perform at least one of calculations for obtaining an average, a median, or a mode for a result value of the gradient aggregation.
